(19) United States
(12) Patent Application Publication
(10) Pub. No.: US 2010/0061663 A1
(43) Pub. Date: Mar. 11, 2010

(54) DISPOSAL BAG FOR HYGIENE PRODUCTS AND METHOD OF MANUFACTURING THE SAME

(75) Inventor: Lina Enlund, Hagersten (SE)

Correspondence Address: Aibihns.Zacco AB, P.O. Box 5581, Valhallavagen 117, STOCKHOLM, SE-114 85, SE

(73) Assignee: Sanett AB, Hagersten (SE)

(21) Appl. No.: 12/439,167

(22) PCT Filed: Aug. 23, 2007
(86) PCT No.: PCT/SE2007/050568

§ 371 Date: Sep. 29, 2009

(30) Foreign Application Priority Data
Sep. 1, 2006 (SE) 0601803-0

(51) Int. Cl. B65D 33/24; B32B 38/04

(52) U.S. Cl. 383/77; 156/251

(57) ABSTRACT

A disposal bag intended for a tampon consists of two square sheets welded together only along two adjacent sides of dimension a. The bag can be easily held open with one hand for reception of the tampon and a closed package can be made by tying the free corners of the bag. The disposal bag can be mass produced very easily and in an inexpensive way by two manufacturing methods, according to which a two layer web 2×a which is twice the width of the bag, is welded continuously along the edges (10b) of the web and transversely at intervals 2×with a double bead (10a). Transverse perforations (11) are stamped (6) at intervals a and the web is cut continuously at its middle (12) and individual tear-off bags are rolled up on two rolls (4a).

### FIELD OF THE INVENTION

“The present invention relates to a disposal bag intended for receiving a used absorbent hygiene article, such as a tampon, comprising a liquid impermeable material provided with an opening intended for insertion of the hygiene article. It is also relates to methods developed when manufacturing such a disposal bag.”

### CROSS REFERENCE TO RELATED APPLICATIONS

This application is a national stage application of International Application, filed 23 Aug. 2007, designating the United States of America, which claims the priority benefit under the Paris Convention of Swedish Patent Application 0601803-0 filed 1 Sep. 2006.

### BACKGROUND OF THE INVENTION

In order to prevent plugged toilets, ladies rooms are usually provided with a supply of bags, in which sanitary napkins and tampons can be enclosed and discarded into a container intended for this purpose. With regard to tampons, however, many women have continued to allow the extracted tampon to drop down into the toilet and be flushed away, sometimes causing significant problems in the sewage system. Smaller bags intended for tampons, which could be used to receive the tampon directly upon extraction with a string, have been suggested e.g. in Japanese Patent Specification No. 2004097251 (to KAO Corporation) and French Patent Specification 2620684. These solutions are, however, complicated in their construction, requiring a number of different steps to manufacture, and use tape or a string for closure. Other solutions which are described e.g. in U.S. Pat. No. 6,402,727 B1 or Japanese Patent Specification 2003180740, comprise a napkin or a sheet of material which is intended to be folded around and enclose the used tampon. These are, however, more difficult to use and require tape or a string to close.

### THE PURPOSE OF THE PRESENT INVENTION

The purpose of the present invention is to achieve a disposal bag which is easy to use for immediate reception of tampons and which is easy to close, manufacture and store before use, with an absolute minimum of material and parts. It is also a purpose of the present invention to achieve a method of rapid, simple and economical manufacture of such bags, which can be supplied in rolls ready for use or subsequent packing steps.

These and other purposes are achieved with a disposal bag intended for receiving a used absorbent hygiene article, such as a tampon, comprising a liquid impermeable material provided with an opening intended for insertion of the hygiene article, wherein the bag consists of two essentially square sheets, lying on top of each other and made of an at least relatively liquid impermeable material, which are bonded to each other along only two of their square sides lying adjacent to each other, said sheets being of such dimensions that the bag permits reception of the hygiene article and subsequent manual tying of the two free corners of the sheets for closing the bag. These and other purposes are achieved with a method of manufacturing identical disposal bags comprising the steps of:

a. advancing of a web of liquid impermeable material having a width which is two times the width a of the disposal bag,
b. with another identical web on top thereof, forming a single double sheet web,
c. continuous welding together along the two sides of the double sheet web,
d. intermittent double bead transversal welding at intervals 2a in the advancing direction of the double sheet web,
e. continuous mid-cutting of the web in the advancing direction of the web,
f. subsequent intermittent cross-cutting or perforation of the double sheet web at each interval a in the advancing direction of the web, with every other cross-cut or perforation in the middle of each double-bead transverse weld.

These and other purposes are achieved with a further method of manufacturing identical disposal bags comprising the steps of:

a. double folding in the longitudinal direction of a web of liquid impermeable material of unfolded width 4a, i.e. four times the width a of the finished disposal bag,
b. advancing of the double folded web of liquid impermeable material and with a width which is two times the width a of the disposal bag,
c. continuous welding together along the edge of the double folded web which is opposite to the folded edge,
e. intermittent double-beaded transverse welding at intervals 2a in the advancing direction of the web,
d. continuous mid-cutting of the web in the advancing direction of the web,
f. subsequent intermittent cross-cutting or perforation of the web at each interval a in the advancing direction of the web with every other cross-cutting or perforation in the middle of each double-beaded transverse welding.

The disposal bag which is impermeable to liquid and odours is very simple to hold open in one hand to receive the tampon when the woman extracts it from her vagina, which prevents unpleasantness and the risk of getting menstrual blood or liquid on clothes etc.

### FIGURES

The present invention will be described below with reference to the accompanying drawings of which:

FIG. 1 shows a disposal bag according to the invention,

FIG. 2 (a-d) shows four steps in the use of the disposal bag according to the invention when receiving a tampon,

FIG. 3 shows how the bags may be welded and cut from a double web of thin plastic material in a first manufacturing process,

FIG. 4 schematically shows how the various components in a manufacturing process according to this first manufacturing method could be arranged.

### DETAILED DESCRIPTION OF PREFERRED EMBODIMENTS

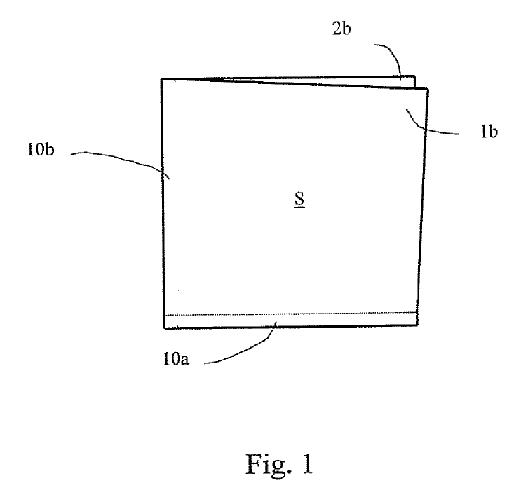

FIG. 1 shows a disposal bag S which consists of a simple square sheet of plastic 1b with a similar square sheet of plastic 2b on top of it. These two sheets are welded together or glued together on only two of their edges 10a and 10b to form the disposal bag S.

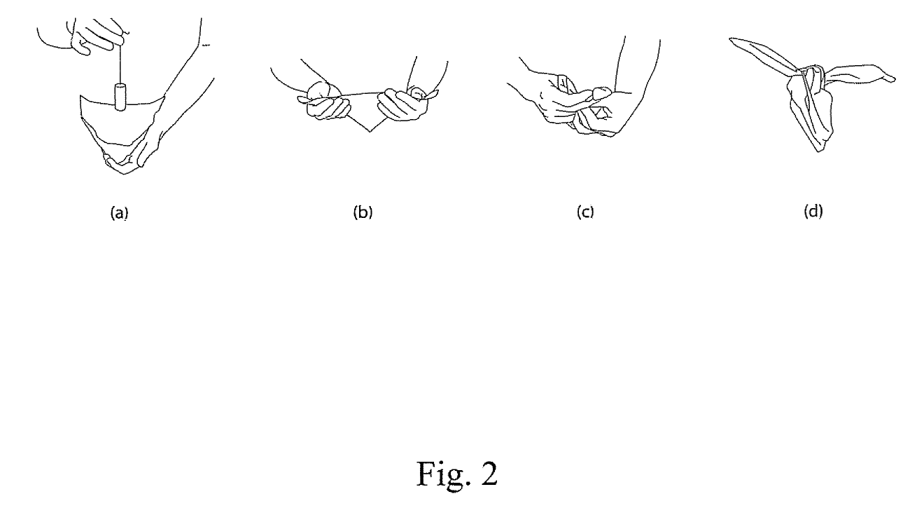

The plastic sheet, or any other material which is impermeable to liquid and odour is sufficiently rigid to keep its open shape when receiving the tampon (FIG. 2(a)) but still sufficiently flexible so that the free corners can be tied together as shown in FIGS. 2 (b)-(c)). FIG. 2(d) shows the resulting package which can be placed in a refuse container or even be placed in a pocket or handbag if it is not possible to dispose of the package directly.

When extracting a used tampon the user is many times unwilling to lift it above the toilet bowl for fear of spoiling clothing or of mere displeasure. In order to rapidly get rid of a used tampon when extracted, the user has often immediately dropped the tampon down into the toilet and flushed it away with the disadvantages to plumbing and sewage treatment which this involves. The wide open bag according to the invention can be held in one hand next to the vagina upon reception of the tampon so that the user never needs to lift up the unprotected tampon.

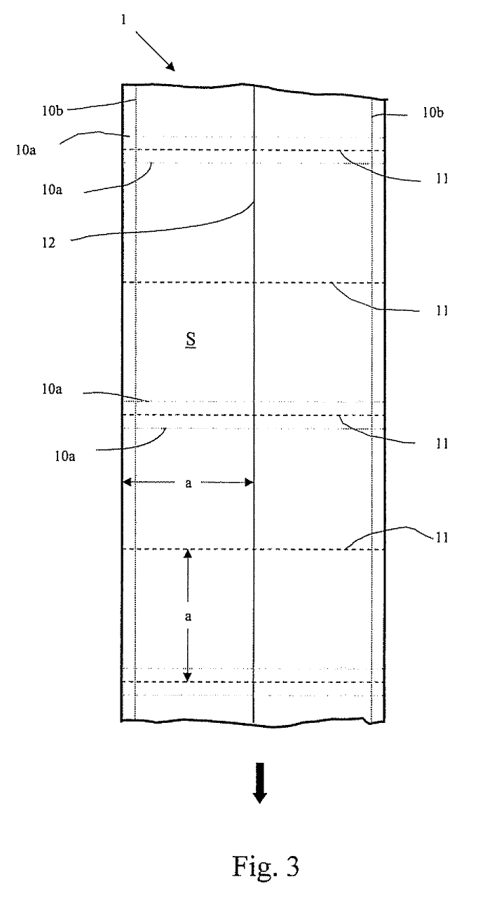

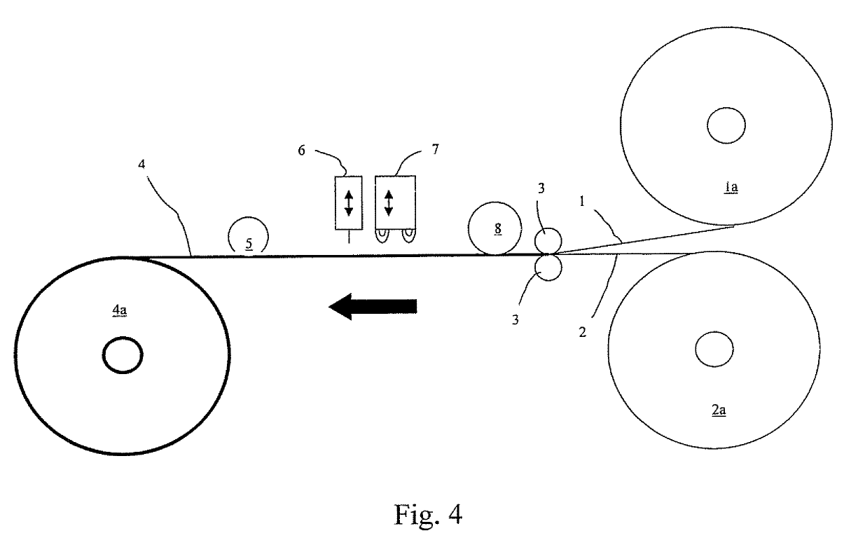

The disposal bag according to the invention is surprisingly simple and economical to manufacture by means of the methods according to the invention. The methods make it possible to deliver bags on rolls with tear-off perforations between the bags for use in this form or for further processing and packaging. FIGS. 3 and 4 show how a double sheet web can be welded and cut according to the invention. The components in FIG. 4, however, are only shown symbolically and the components can be arranged in another order within the scope of the invention. The double sheet web consists, according to a first embodiment, of two identical sheets 1 and 2, of width 2a, which run from two different rolls 1a and 2a. The two different webs 1 and 2 are brought together by two rollers 3, whereafter two welding rollers 8 provide two longitudinal welding lines 10b along either side of the sheeting web. The welding rollers 8 are only shown schematically here and have of course counter rolls or support plates on the other side of the web which are not shown. Glueing, laser welding or ultra-sonic welding can of course replace the schematically shown welding wheels 8. A pair of transverse weld lines 10a are made at even spacing “2×a” as the web is advanced. These welding components are shown schematically as component 7, which is lowered intermittently at the correct moment. This component can of course also be replaced by other welding means such as laser welding or ultra-sonic welding means. A transverse perforation instrument 6 extends transversely across the web and produces perforation lines 11 at even spacing “a” as shown in FIG. 3. Thereafter, the cutting disc 5 cuts the web into two parts and two webs of bags are rolled up on two rolls 4a.

According to a second method of manufacture according to the invention, the double layer of plastic sheeting in the web is achieved by folding in the middle the plastic sheeting longitudinally when rolled off from a roll of width 4×a. This will make one of the longitudinal welds 10b in the first method described above unnecessary.

It is also possible of course to cut the web in both methods instead of making perforations 11 and thereafter collecting the individual bags. The simple and thin form of the bags makes it possible to include a suitable number of disposal bags in the cover of a package of tampons.

1. Disposal bag intended for receiving a used absorbent hygiene article, such as a tampon, comprising a liquid impermeable material, and provided with an opening intended for insertion of the hygiene article, wherein the bag consists of two essentially square sheets, lying on top of each other and made of an at least relatively liquid impermeable material, which are bonded to each other along only two of their square sides lying adjacent to each other, said sheets being of such dimensions that the bag permits reception of the hygiene article and subsequent manual tying of the two free corners of the sheets for closing the bag.

2. Disposal bag according to claim 1, wherein the two sheets lying on top of each other are bonded to each other along one of their square sides, one material sheet being made in one piece with the other which is folded over said one sheet.

3. Disposal bag according to claim 1, wherein one or both of the bonds are achieved by welding.

4. Disposal bag according to claim 1, wherein one or both of the bonds are achieved by gluing.

5. Method of manufacturing identical disposal bags according to claim 1, comprising the following steps:
a. advancing of a web of liquid impermeable material having a width which is two times the width a of the disposal bag,
b. with another identical web on top thereof, forming a single double sheet web,
c. continuous welding together along the two sides of the double sheet web,
d. intermittent double bead transversal welding at intervals 2a in the advancing direction of the double sheet web,
e. continuous mid-cutting of the web in the advancing direction of the web,
f. subsequent intermittent cross-cutting or perforation of the double sheet web at each interval a in the advancing direction of the web, with every other cross-cut or perforation in the middle of each double-bead transverse weld.

6. Method of manufacturing disposal bags according to claim 1, comprising the following steps:
a. double folding in the longitudinal direction of a web of liquid impermeable material of unfolded width 4a, i.e. four times the width a of the finished disposal bag,
b. advancing of the double folded web of liquid impermeable material and with a width which is two times the width a of the disposal bag,
c. continuous welding together along the edge of the double folded web which is opposite to the folded edge,
e. intermittent double-beaded transverse welding at intervals 2a in the advancing direction of the web,
d. continuous mid-cutting of the web in the advancing direction of the web,
f. subsequent intermittent cross-cutting or perforation of the web at each interval a in the advancing direction of the web with every other cross-cutting or perforation in the middle of each double-beaded transverse welding.
